(19) United States
(12) Patent Application Publication
(10) Pub. No.: US 2013/0081464 A1
(43) Pub. Date: Apr. 4, 2013

(54) INERTIAL SENSOR

(71) Applicants: Heung Woo Park, Gyunggi-do (KR); Min Kyu Choi, Incheon (KR); Jong Woon Kim, Seoul (KR); Sung Jun Lee, Gyunggi-do (KR)

(72) Inventors: Heung Woo Park, Gyunggi-do (KR); Min Kyu Choi, Incheon (KR); Jong Woon Kim, Seoul (KR); Sung Jun Lee, Gyunggi-do (KR)

(73) Assignee: SAMSUNG ELECTRO-MECHANICS CO., LTD., Gyunggi-do (KR)

(21) Appl. No.: 13/324,879

(22) Filed: Dec. 13, 2011

(30) Foreign Application Priority Data
Sep. 29, 2011 (KR) 1020110099071

(51) Int. Cl. G01C 19/56

(52) U.S. Cl. 73/504.12

(57) ABSTRACT

Disclosed herein is an inertial sensor. The inertial sensor includes a sensor part including a driving mass, a flexible substrate part displaceably supporting the driving mass, and a support part supporting the flexible substrate part so that the driving mass is freely movable in a state in which the driving mass is floated; a lower cap covering a lower portion of the driving mass and coupled with the support part and provided with a stopper part limiting a displacement of the driving mass; and a dry film resist coupling the sensor part with the cover and providing an interval between the driving mass and the stopper.

### CROSS REFERENCE TO RELATED APPLICATION

This application claims the benefit of Korean Patent Application No. 10-2011-0099071, filed on Sep. 29, 2010, entitled “Inertial Sensor,” which is hereby incorporated by reference in its entirety into this application.

### BACKGROUND OF THE INVENTION

1. Technical Field

The present invention relates to an inertial sensor.

2. Description of the Related Art

Generally, an inertial sensor measuring acceleration and/or angular velocity has been widely used while being mounted in a motion remote controller for screen conversion of a mobile phone, a game, and a digital TV, a remote controller of a game machine, and a sensor module, or the like, for sensing hand shaking and sensing a position and an angle of motion, or the like.

In addition, the inertial sensor senses motion as acceleration or angular velocity and converts the sensed information into an electrical signal. Therefore, when a device is operated by using a user's motion as an input, it is possible to implement a motion interface. In addition, the inertial sensor has been widely used in a navigation and control sensor of an airplane and a vehicle, in addition to a motion sensor such as home appliances, or the like.

Further, as the inertial sensor is used for a portable PDA, a digital camera, or a mobile phone, or the like, a need exists for a technology capable of implementing a compact and light inertial sensor with various functions. As a result, a development of a micro-sensor module has been demanded.

In addition, an inexpensive and micro-inertial sensor for a personal portable product has mainly used a capacitive type and a type using a piezoelectric element. A driving unit of the inertial sensor may be sorted into a piezo-electric type and a capacitive type and a sensing unit thereof may be sorted into a piezo-electric type, a capacitive type, and a piezoresistive type.

Further, in the case of an inertial sensor using a piezoelectric element among the inertial sensors according to the prior art, a silicon structure includes a driving mass, a flexible substrate part, and a support body, wherein the flexible substrate part is provided with a vibrating electrode and a sensing electrode, current is applied to the vibrating electrode to thereby drive the driving mass, and the sensing electrode senses displacement of the driving mass due to the driving of the driving mass.

In addition, when the inertial sensor according to the prior art drops in an axis direction or is applied with an impact, the flexible substrate part may be damaged. In order to solve the problem, a method for forming a stopper on the lower portion of the driving mass has been developed, which may make the structure very complicated and may not implement delicate design structure.

### SUMMARY OF THE INVENTION

The present invention has been made in an effort to provide an inertial sensor capable of constantly and accurately maintaining an interval between a driving mass of a sensor part and a stopper part of a lower cap by forming a stopper on the lower cap and combining the sensor part with the lower cap using a dry film resist (DFR).

According to a preferred embodiment of the present invention, there is provided an inertial sensor, including: a sensor part including a driving mass, a flexible substrate part displaceably supporting the driving mass, and a support part supporting the flexible substrate part so that the driving mass is freely movable in a state in which the driving mass is floated; a lower cap covering a lower portion of the driving mass and coupled with the support part and provided with a stopper part limiting a displacement of the driving mass; and a dry film resist coupling the sensor part with the cover and providing an interval between the driving mass and the stopper.

The lower cap facing the support part may be provided with an adhesive accommodating groove to which the DFR is applied and a thickness of the DFR is formed so as to be larger by 1 μm to 20 μm than a depth of the adhesive accommodating groove.

The lower cap may include: a coupling part protruded to face the support part; and a cavity facing the driving mass, wherein the stopper part is formed in the cavity, protruded toward the driving mass, and spaced apart from the driving mass at a predetermined interval to limit a downward displacement of the driving mass.

The stopper part may be formed so that one stopper part is formed to be protruded from the lower cap while facing a bottom central portion of the driving mass.

The plurality of stopper parts may be formed to be protruded from the lower cap so that the stopper parts are disposed at equidistance while facing the lower edge portion of the driving mass.

One of two to eight stopper parts may be selected.

The stopper part may be formed to have a diameter of 10 μm to 200 μm.

The DFR may perform lamination coating on the adhesive accommodating groove of the lower cap.

In the DFR, breakdown voltage may be 280V/μm, volume resistivity is 2×10¹⁴ Ωm, tensile strength is 20 MPa, and Young's Modulus (25° C.) is 400 MPa.

The thickness of the DFR may be 20 μm and the depth of the adhesive accommodating groove may be 16 μm.

The lower cap may include: a coupling part protruded to face the support part; and a cavity facing the driving mass, wherein the stopper part extending toward the cavity from the coupling part so that a portion of the stopper part is disposed to face the lower portion of the driving mass and may be disposed so as to be spaced apart from the driving mass at a predetermined interval to limit the downward displacement of the driving mass.

The support part facing the lower cap may be provided with an adhesive accommodating groove to which the DFR is applied and the thickness of the DFR may be formed so as to be larger by 1 μm to 20 μm than the depth of the adhesive accommodating groove

The thickness of the DFR may be 20 μm and the depth of the adhesive accommodating groove may be 16 μm.

### BRIEF DESCRIPTION OF THE DRAWINGS

FIG. 1 is a schematic cross-sectional view of an inertial sensor according to a first preferred embodiment of the present invention;

FIG. 2 is a schematic cross-sectional view of an inertial sensor according to a second preferred embodiment of the present invention;

FIG. 3 is a schematic plan view of a stopper part according to a first preferred embodiment of the present invention in the inertial sensor of FIG. 1;

FIG. 4 is a schematic plan view of a stopper part according to a second preferred embodiment of the present invention in the inertial sensor of FIG. 1;

FIG. 5 is a schematic plan view of a stopper part according to a third preferred embodiment of the present invention in the inertial sensor of FIG. 1;

FIG. 6 is a schematic plan view of a stopper part according to a fourth preferred embodiment of the present invention in the inertial sensor of FIG. 1;

FIG. 7 is a schematic cross-sectional view of an inertial sensor according to a third preferred embodiment of the present invention; and

FIG. 8 is a schematic cross-sectional view of an inertial sensor according to a fourth preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, an inertial sensor according to preferred embodiments of the present invention will be described with reference to the accompanying drawings.

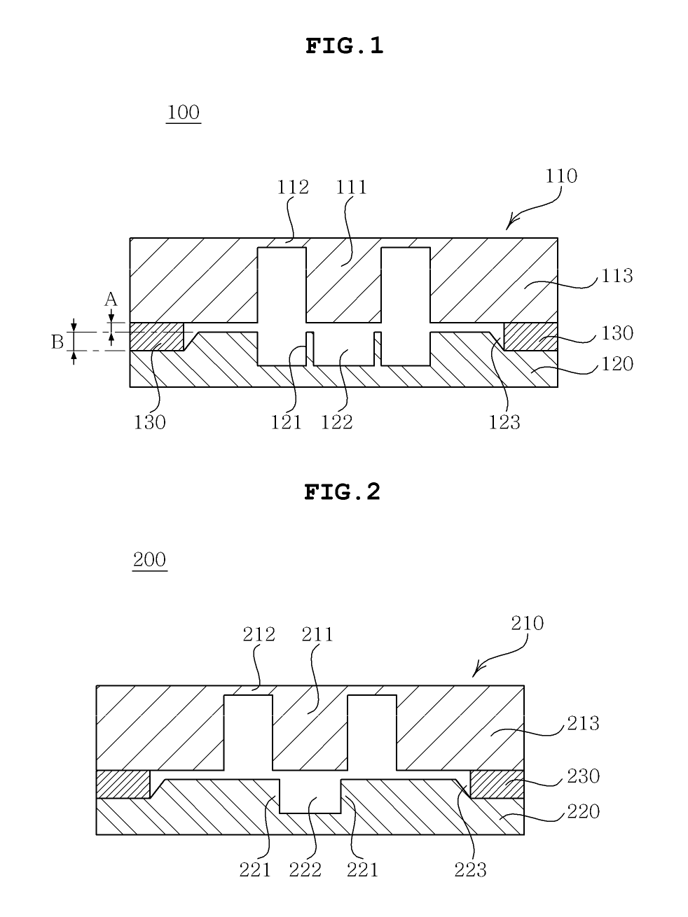

FIG. 1 is a schematic cross-sectional view of an inertial sensor according to a first preferred embodiment of the present invention. As shown in FIG. 1, an inertial sensor 100 includes a sensor part 110 and a lower cap 120, wherein the sensor part 110 is coupled with the lower cap 120 by a dry film resist 130.

Herein, the sensor part 110 includes a driving mass 111, a flexible substrate part 112, and a support part 113. In addition, the flexible substrate part 112, which is displaceably support the driving mass 111, includes a flexible substrate, a piezoelectric material (PZT), and an electrode. In addition, the flexible substrate is configured of a silicon substrate or a silicon on insulator (SOI) substrate and is provided with a driving electrode (not shown) and a sensing electrode (not shown) by depositing a piezoelectric element and an electrode.

In addition, the driving mass 111 is disposed to move downwardly toward the flexible substrate part 112 and the driving mass 111 moves according to the application of voltage to the driving electrode on the flexible substrate part 112.

In addition, the support part 113 supports the flexible substrate part 112 so that the driving mass 111 may freely move in a floating state.

Further, the driving mass 111 and the support part 113 according to the preferred embodiment of the present invention may be formed by etching a silicon substrate.

In addition, the lower cap 120 is to support the sensor part 110 to the ASIC (not shown) while covering the lower portion of the driving mass 111.

In more detail, the lower cap 120 is provided with a coupling part coupled with the sensor part 110, a stopper part 121, a cavity 122, and an adhesive accommodating groove 123. Further, the coupling part is protruded so as to face the support part 113 of the sensor part 110 and the cavity 122, which is to obtain air damping due to the movement of the driving mass 111 and efficient frequency characteristics, is formed to face the driving mass 111. In addition, the stopper part 121 is spaced apart from the driving mass 111 at a predetermined interval to limit a downward displacement of the driving mass and is provided with the cavity 122 so as to be protruded toward the driving mass. In addition, the stopper part may be formed to have a diameter of 10 μm to 100 μm. The size of the stopper part is set in consideration of a minimum function and workability.

In addition, the adhesive accommodating groove 123 is to set the interval between the driving mass and the stopper part through a thickness of the DFR 130 inserted into the adhesive accommodating groove 123 when the DFR 130 is subjected to lamination coating.

Further, the lower cap 120 may be made of silicon that is the same material as the driving mass 111 and the support part 113 or may be made of Pyrex glass, etc., having a similar thermal expansion coefficient. However, it is preferable that the lower cap 120 is made of silicon that is the same material as the driving mass 111 and the support part 113 in consideration of workability and process capability.

In addition, in the DFR 130 according to the preferred embodiment of the present invention, breakdown voltage may be 280V/μm, volume resistivity may be 2×10¹⁴ Ωm, tensile strength may be 20 MPa, and Young's Modulus (25° C.) may be 400 MPa. Further, the DFR 130 is applied to the adhesive accommodating groove 123 of the lower cap 120 by the lamination coating and coupled with the support part 113 of the sensor part 110 to provide an interval between the driving mass 111 of the sensor part 110 and the stopper 121.

In more detail, the driving mass 111 and the stopper part 121 of the sensor part are spaced apart from each other by “A” that is a difference between a depth of the adhesive accommodating groove shown by “B” in FIG. 1 and a thickness of the DFR 130 to freely move the driving mass 111 and limit the axial movement to a predetermined range so as not to damage the flexible substrate part due to the movement of the driving mass.

In more detail, when the interval between the driving mass 111 and the stopper part 121 may be formed at 5 μm, the DFR having 20 μm is provided and the depth of the adhesive accommodating groove is formed at 16 μm, and the DFR is applied to the adhesive accommodating groove. In addition, the thickness of the DFR 130 may be largely made by 3 μm to 5 μm than the depth of the adhesive accommodating groove 123. When the interval between the driving mass 111 and the stopper part 121 is formed at 5 μm or more, the flexible substrate part may be damaged.

The interval between the driving mass 111 of the sensor part and the stopper part 121 of the lower cap may be accurately and constantly formed by a simple method by the above configuration and performing the lamination coating on the DFR inserted into the adhesive accommodating groove.

FIG. 2 is a schematic cross-sectional view of an inertial sensor according to a second preferred embodiment of the present invention. As shown in FIG. 2, the inertial sensor 200 is the same as the inertial sensor 100 shown in FIG. 1 except for only the lower cap for forming the stopper part.

In more detail, the inertial sensor 200 includes a sensor part 210 and a lower cap 220, wherein the sensor part 210 is coupled with the lower cap 220 by a dry film resist 230.

Further, the sensor part 210 is configured to include a driving mass 311, a flexible substrate part 212, and a support part 213 and the lower cap 220 is provided with a coupling part coupled with the sensor part 210, a cavity 222, a stopper part 221, and an adhesive accommodating groove 223.

In addition, the stopper part 221 of the inertial sensor 200 according to a second preferred embodiment of the present invention extends toward the cavity from the coupling part and is positioned so as to be spaced apart from the driving mass 211 at a predetermined interval to limit a downward displacement of the driving mass to a safe range in which the flexible substrate part is not damaged.

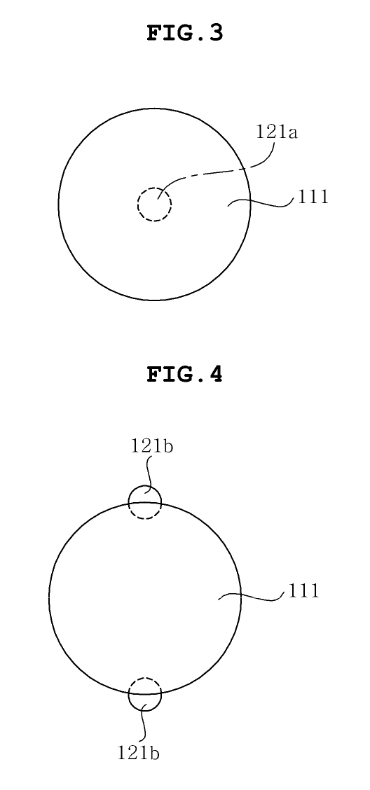

FIG. 3 is a schematic plan view of a stopper part according to a first preferred embodiment of the present invention in the inertial sensor of FIG. 1. As shown, a stopper part 121a is formed so that one stopper part 121a is formed to be protruded from the lower cap while facing a bottom central portion of the driving mass 111.

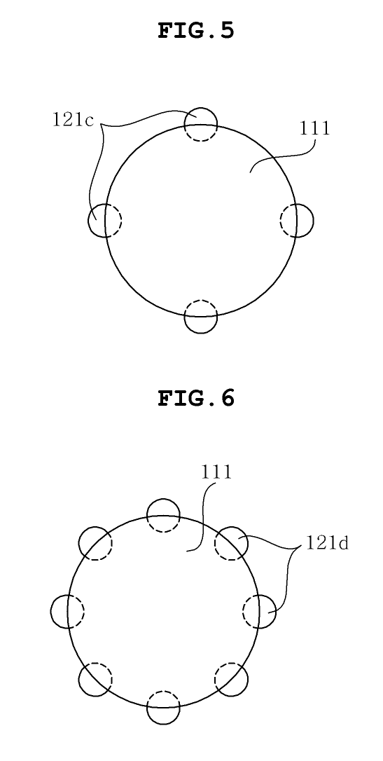

FIG. 4 is a schematic plan view of a stopper part according to a second preferred embodiment of the present invention in the inertial sensor of FIG. 1, FIG. 5 is a schematic plan view of a stopper part according to a third preferred embodiment of the present invention in the inertial sensor of FIG. 1, and FIG. 6 is a schematic plan view of a stopper part according to a fourth preferred embodiment of the present invention in the inertial sensor of FIG. 1.

As shown, in FIG. 4, two stopper parts 121b are formed to be protruded from the lower cap so that the stopper parts 121 b are disposed at equidistance while facing the lower edge portion of the driving mass 111. In addition, in FIG. 5, four stopper parts 121c are formed to be protruded from the lower cap so that the stopper parts 121c are disposed at equidistance while facing the lower edge portion of the driving mass 111. In addition, in FIG. 6, eight stopper parts 121 c are formed to be protruded from the lower cap so that the stopper parts 121 c are disposed at equidistance while facing the lower edge portion of the driving mass 111.

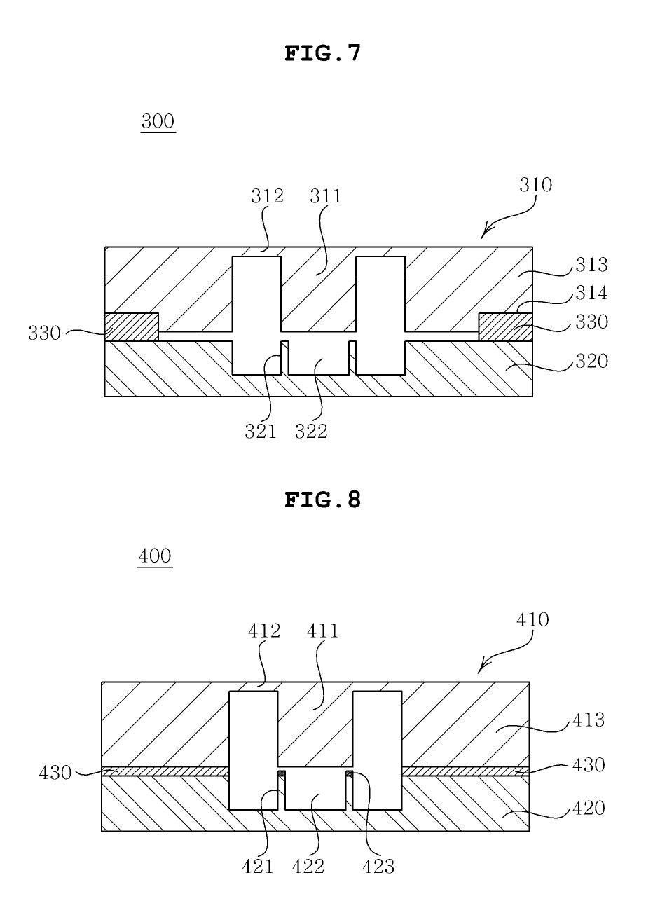

FIG. 7 is a schematic cross-sectional view of an inertial sensor according to a third preferred embodiment of the present invention. As shown in FIG. 2, an inertial sensor 300 is the same as the inertial sensor 100 shown in FIG. 1 except for only an object in which the adhesive accommodating groove is formed. That is, in the inertial sensor 100 according to the first preferred embodiment of the present invention, the adhesive accommodating groove 223 is formed on the lower cap. On the other hand, in the inertial sensor 300 according to the third preferred embodiment of the present invention, the adhesive accommodating groove is formed on a sensor part 310.

In more detail, the inertial sensor 300 includes the sensor part 310 and a lower cap 320, wherein the sensor part 310 is coupled with the lower cap 320 by a dry film resist 330.

Further, the sensor part 310 includes a driving mass 311, a flexible substrate part 312, and a support part 313, wherein the adhesive accommodating groove 314 is formed on the support part 313. Further, the lower cap 320 is provided a coupling part coupled with the sensor part 310, a cavity 322, a stopper part 321.

In addition, in the inertial sensor 300 according to the third preferred embodiment of the present invention, the adhesive accommodating groove 314 is formed on the support part 313 of the sensor part 310, a DFR 330 is applied to the adhesive accommodating groove 314, and since the sensor part 310 is coupled with the lower cap 320, the stopper part 321 is spaced apart from the driving mass 211 at a predetermined interval to limit a downward displacement of the driving mass to a safe range in which the flexible substrate part is not damaged.

To this end, the thickness of the DFR 330 may be largely made by 3 μm to 5 μm than the depth of the adhesive accommodating groove 314. In addition, in order to form the interval between the driving mass and the stopper part at 5 μm, the thickness of the DFR may be set to be 20 μm and the depth of the adhesive accommodating groove may be set to be 16 μm.

FIG. 8 is a schematic cross-sectional view of an inertial sensor according to a fourth preferred embodiment of the present invention. As shown, the inertial sensor according to the fourth preferred embodiment of the present invention is different from the inertial sensor according to the first preferred embodiment of the present invention except for only the structure of the lower cap and the stopper part.

In more detail, an inertial sensor 400 includes a sensor part 410 and a lower cap 420, wherein the sensor part 410 is coupled with the lower cap 420 by a dry film resist 430.

Further, the sensor part 410 includes a driving mass 411, a flexible substrate part 412, and a support part 413. In addition, in the inertial sensor according to the fourth preferred embodiment of the present invention, the lower cap 420 is provided with a stopper part 421, a cavity 422, and a buffer member 424. In addition, the buffer member 424 is formed to face the driving mass 411. Therefore, when the driving mass 411 collides with the stopper part 421, the impact is reduced by the buffer member 424 to prevent the driving mass from being damaged, thereby previously preventing the sensing errors.

In addition, since the thickness of the buffer member is set to be 16 μm and the thickness of the DFR is set to be 20 μm, the interval between the driving mass 411 and the buffer member 424 may be set to be 1 to 10 μm.

Further, the buffer member 424 may be variously implemented by low elastomer, polymer, or the like.

As set forth above, the preferred embodiments of the present invention can implement the inertial sensor capable of constantly and accurately maintaining the interval between the driving mass of the sensor part and the stopper part of the lower cap by forming the stopper on the lower cap and combining the sensor part with the lower cap using the dry film resist (DFR).

Although the embodiment of the present invention has been disclosed for illustrative purposes, it will be appreciated that an inertial sensor according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a sensor part including a driving mass, a flexible substrate part displaceably supporting the driving mass, and a support part supporting the flexible substrate part so that the driving mass is freely movable in a state in which the driving mass is floated;
a lower cap covering a lower portion of the driving mass and coupled with the support part and provided with a stopper part limiting a displacement of the driving mass; and
a dry film resist coupling the sensor part with the cover and providing an interval between the driving mass and the stopper.

2. The inertial sensor as set forth in claim 1, wherein the lower cap facing the support part is provided with an adhesive accommodating groove to which the DFR is applied and a thickness of the DFR is formed so as to be larger by 1 μm to 20 μm than a depth of the adhesive accommodating groove.

3. The inertial sensor as set forth in claim 1, wherein the lower cap includes:
a coupling part protruded to face the support part; and
a cavity facing the driving mass,
the stopper part being formed in the cavity, protruded toward the driving mass, and spaced apart from the driving mass at a predetermined interval to limit a downward displacement of the driving mass.

4. The inertial sensor as set forth in claim 3, wherein the stopper part is formed so that one stopper part is formed to be protruded from the lower cap while facing a bottom central portion of the driving mass.

5. The inertial sensor as set forth in claim 3, wherein the plurality of stopper parts are formed to be protruded from the lower cap so that the stopper parts are disposed at equidistance while facing the lower edge portion of the driving mass.

6. The inertial sensor as set forth in claim 5, wherein one of two to eight stopper parts is selected.

7. The inertial sensor as set forth in claim 3, wherein the stopper is formed to have a diameter of 10 μm to 200 μm.

8. The inertial sensor as set forth in claim 2, wherein the DFR performs lamination coating on the adhesive accommodating groove of the lower cap.

9. The inertial sensor as set forth in claim 8, wherein in the DFR, breakdown voltage is 280V/μm, volume resistivity is 2×10¹⁴ Ωm, tensile strength is 20 MPa, and Young's Modulus (25° C.) is 400 MPa.

10. The inertial sensor as set forth in claim 2, wherein the thickness of the DFR is 20 μm and the depth of the adhesive accommodating groove is 16 μm.

11. The inertial sensor as set forth in claim 1, wherein the lower cap includes:
a coupling part protruded to face the support part; and
a cavity facing the driving mass,
the stopper part extending toward the cavity from the coupling part so that a portion of the stopper part is disposed to face the lower portion of the driving mass and is disposed so as to be spaced apart from the driving mass at a predetermined interval to limit the downward displacement of the driving mass.

12. The inertial sensor as set forth in claim 1, wherein the support part facing the lower cap is provided with an adhesive accommodating groove to which the DFR is applied and the thickness of the DFR is formed so as to be larger by 1 μm to 20 μm than the depth of the adhesive accommodating groove.

13. The inertial sensor as set forth in claim 12, wherein the thickness of the DFR is 20 μm and the depth of the adhesive accommodating groove is 16 μm.

14. The inertial sensor as set forth in claim 1, wherein the stopper part is provided with a buffer member so as to face the driving mass.
